(19) United States
(12) Patent Application Publication
(10) Pub. No.: US 2008/0137718 A1
(43) Pub. Date: Jun. 12, 2008

(54) WIRELESS COMMUNICATION METHOD AND APPARATUS FOR ALLOCATING TRAINING SIGNALS AND INFORMATION BITS

(75) Inventors: Inhyok Cha, Yardley, PA (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/950,749

(22) Filed: Dec. 5, 2007

Related U.S. Application Data
(60) Provisional application No. 60/869,023, filed on Dec. 7, 2006.

(51) Int. Cl. H04B 1/707; H04L 27/20; H04L 27/22; H04L 27/28

(52) U.S. Cl. 375/146; 375/295; 375/308; 375/341; 375/329; 375/260; 375/E01.002

(57) ABSTRACT

Techniques of channel correction and demodulation for orthogonal frequency division multiplexing (OFDM) systems are enhanced so that higher effective data rates and/or lower error rates can be achieved with a minimal processing load. Pilots are adaptively moved and/or removed, and their positions are changed, to enhance the channel estimation, decoding, and demodulation processes at the receiver. Reception is also enhanced by adding, removing, or changing the positions, of information-carrying data bits.

### CROSS REFERENCE TO RELATED APPLICATION

This application claims the benefit of U.S. Provisional Application No. 60/869,023 filed Dec. 7, 2006, which is incorporated by reference as if fully set forth.

### BACKGROUND

High-performance demodulation of orthogonal frequency division multiplexing (OFDM) signals requires accurate and sufficiently frequent characterization of the time-frequency channel that the signals experience. Once channels are fully characterized or, equivalently, “estimated”, such channel estimates can be used to maximize the effects of the channels in optimum demodulation of signals that underwent the channels. Typically, this process is called “channel equalization”.

In modern wireless communication systems, where OFDM is the modulation technique of choice, such as the European Computer Manufacturers Association (ECMA)-368 ultra-wideband (UWB) personal area networks (PAN) systems, the characterization of the channels is typically performed by having two sets of signals. The first signal is called the preamble, and its pre-channel signal composition is fully known at the receiver on all time and frequency samples that comprise the preamble signal. Preambles are typically pre-pended before the data part of a packet. Using interpolation of channel estimates obtained from adjacent packets' preambles, an estimate may be obtained of the time-frequency channel that the data part may experience.

The second type of signal that is useful in further assisting channel characterization and eventual equalization are the pilots. The pilots are known signals that occupy a subset of the entire time-frequency sample space of the post-preamble part of a packet, and typically comprise multiple single or small-subset samples that are regularly dispersed in the time and frequency sample space of the post-preamble part of a packet. Again, using interpolation among the pilot samples, and/or using also the preamble parts, one can obtain an estimate of the channel. FIG. 1 shows examples of distributing pilots across a typical time-frequency channel space.

The problems addressed herein are related to the fact that UWB systems a typically subject to impairment by narrower-band signals and noises both natural and man-made, due to their large bandwidth and the abundance of interferences and noise sources that can impact only part of the spectral area of the UWB system. The UWB systems in the prior art do not provide methods where the transmitting side can ‘evade’ known sources of interferers in the time-frequency domain of operation. Nor does the prior art address mitigating the negative impacts of such interferers, as prior art methods use ‘fixed’ placement of reference signals in the time-frequency resource map of the transmitted signal.

A typical UWB wireless communication channel, due to its large bandwidth, typically is not homogeneous across its operating frequency, even without the presence of explicit interference sources. For example, if two UWB devices move relative to each other, for example, by being carried around by users of UWB equipped mobile devices, the operating frequencies in the channel may experience very different degrees of distortion because the Doppler Effect would affect different sub-frequencies contained the large bandwidth of the channel in different degrees.

Therefore, for UWB OFDM signals such as those compliant with the ECMA 368 UWB standards, there are multiple places in the frequency domain where the channel may experience drastically increased interference due to presence of narrowband interferers, both man-made and natural, and resulting degradation. The signal-to-noise ration of such channel sub-spaces, are much lower than in the rest of the channel space.

One problem of prior art UWB systems is that the transmitters of such systems have ‘fixed’ or ‘invariable’ placement of the training signals in the frequency and time domains. In UWB OFDM systems the fixed allocation or placement of the training-symbol resources that should be reliably detected to assist high-performance reception of the data symbols becomes problematic.

Another problem of prior art systems is that prior art UWB OFDM systems do not exploit the lack of homogeneity of the channels for data transmission. These systems do not adaptively or variably allocate the data symbols in response to their knowledge of the channel conditions. This results in sub-optimum utilization of the capacity of the channel and is a problem commonly known to many different types of wireless communications systems. However, the effect of this problem is greater for UWB systems, as opposed to narrow band systems, due to their large operating bandwidths and ensuing larger chances of interferences and the larger degree of channel in-homogeneity.

One way to deal with some of the problems described above is to use error correction coding on the control and data symbols in the transmitter. When channel conditions deteriorate locally and result in errors in symbol detection at the receiver, the presence of redundant, distributed information about the original signal in the transmitted waveform allows the receiver to recover the original symbols by using decoding techniques.

Another way traditional methods used to alleviate the problems is to allocate a significant portion of time-frequency resources of the transmitted waveform to the known, training signal, so that, even when impairments take place for a subset of the training symbols, the rest of the training symbols may be sufficient to be useful in recovering channel information and assisting the demodulation of the data symbols. Typically in OFDM systems, training signals, comprised of preambles and pilots, can take up 10% or more of the time-frequency resources. However, this method can typically result in over allocation of training signal, since the design of the system would typically have to be done for the worst-case provisioning of the training symbols. The result of such over allocation would be under utilization of the true capacity of the channel, for the transmission of the actual, information-carrying data symbols.

In order to compensate for the fact that the determined correction values are not perfect for various channel parameters, the parameters used to encode the data are adjusted. Thus, the prior art used adaptive modulation coding (AMC) to adaptively distribute information bits in order to optimally exploit available channel capacity that changes dynamically. In AMC, the transmitter adaptively selects one of many modulation and coding schemes, usually changeable per packet basis, depending on the quality of the channel which the transmitter anticipates its transmitted packet will go through. In the ECMA-358 UWB systems, for example, there are 8 different AMC modes that provide, on a per packet basis, an adaptive method to allocate bits across a packet.

Table 1 below depicts the data rates available in the ECMA-368 AMC modes. In general, a lower coding rate (i.e., data/all symbols) and a lower coded bit per symbol rate improve the likelihood of correct decoding in the presence of signal distortion. The distortion could of course also be due to factors such as noise or interferers, which is not directly addressed by the compensating for the channel parameters. It is indirectly addressed in that the compensation is biased towards the desired signals and probably makes the undesired more randomized. The negative of using either approach is that the effective data rate of quadrature phase shift keying (QPSK) modulation and double carrier modulation (DCM) is impacted as shown in the left most column of Table 1.

TABLE 1

| | | | | | Coded Bits/ | Info Bits/6 |
|---|---|---|---|---|---|---|
| Data | | Coding | | | 6 OFDM | OFDM |
| Rate | Modu- | Rate | | | Symbol | Symbol |
| (Mb/s) | lation | (R) | FDS | TDS | (N_{CBP6S}) | (N_{IBP6S}) |
| 53.3 | QPSK | 1/3 | YES | YES | 300 | 100 |
| 80 | QPSK | 1/2 | YES | YES | 300 | 150 |
| 106.7 | QPSK | 1/3 | NO | YES | 600 | 200 |
| 160 | QPSK | 1/2 | NO | YES | 600 | 300 |
| 200 | QPSK | 5/8 | NO | YES | 600 | 375 |
| 320 | DCM | 1/2 | NO | NO | 1200 | 600 |
| 400 | DCM | 5/8 | NO | NO | 1200 | 750 |
| 480 | DCM | 3/4 | NO | NO | 1200 | 900 |

The disadvantages of the prior are in continuous channel estimation and signal extraction in UWB OFDM systems are:

1) lack of adaptive allocation of training signals within a packet; and

2) lack of adaptive allocation of information bits on the time-frequency channel plane within a packet.

As to the lack of adaptive allocation of training signals within a packet, traditional UVB systems such as the ECMA-368 system use methods of fixed allocation of training signals such as the pilots or the preambles, regardless of the condition of the channel. Therefore, they can experience impairments to the training signals if the allotted training signals are placed in the parts of the time-frequency channel space where significant impairments take place.

As to the lack of adaptive allocation of information bits on the time-frequency channel plane within a packet, due to the very wide bandwidths and also due to the fact that these devices are able to roam due to their small form-factors and usage models, (e.g., attached to a personal digital assistant (PDA) and carried around all the time, a WTRU, and the like), the UWB devices can easily face narrower-band interferences, both man-made and natural, that may vary in time and frequency. The transmitters in the current UWB OFDM systems do not allocate the information-carrying data bits within a packet, adaptively according to the changing or anticipated conditions of the communication channel.

However, it is known that UWB channels may undergo impairments on certain time-frequency slots on a time-varying basis, even during the relatively short time period spanning individual packets. If such impairments take place on a large-scale basis, for example, in a significant portion of the time-frequency plane, and in a way that impairs the optimal use of the previously allocated preambles and pilots, large portions of data, even when strongly encrypted using channel codes, may not be recoverable at the receiver.

### SUMMARY

Techniques of channel correction and demodulation for OFDM systems are enhanced so that higher effective data rates and/or lower error rates can be achieved with a minimal processing load. Pilots are adaptively moved and/or removed, and their positions are changed, to enhance the channel estimation, decoding, and demodulation processes at the receiver. Reception is also enhanced by adding, removing, or changing the positions, of information-carrying data bits.

### BRIEF DESCRIPTION OF THE DRAWINGS

The foregoing summary and the following detailed description will be better understood when read with reference to the appended drawings, wherein:

FIG. 1 shows an example of pilot distribution across a typical time-frequency channel space;

FIG. 2 shows conventional ECMA-368 frame structure;

FIG. 3 shows a simplified ECMA-368 frame structure;

FIG. 4 shows a representation of moving pilots and data in the frequency domain;

FIG. 5 is a representation of a physical layer convergence protocol (PLCP) header in ECMA-368 UWB orthogonal frequency domain multiplexed packet format;

FIG. 6 is a representation of pilot removal and addition in the frequency domain;

FIG. 7 depicts how a transmitter append and scrambling unit is used to format a scrambled physical layer service data unit (PSDU) in ECMA-368;

FIG. 8 shows an example of a transmitter;

FIG. 9 shows an example of a receiver; and

FIG. 10 is an example of a block diagram of an OFDM transmitter.

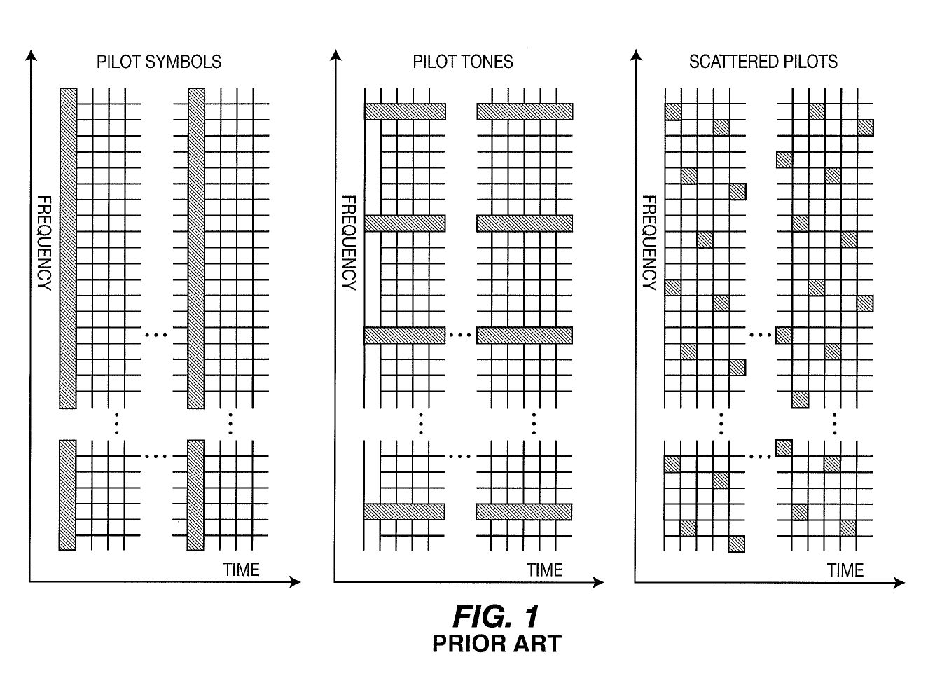

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

For the purpose of illustration, the general structure of the ECMA-368 standard is presented. It will be recognized that this is just one implementation, and can be extended to other implementations with a change in values of certain parameters while still falling under the scope of this disclosure.

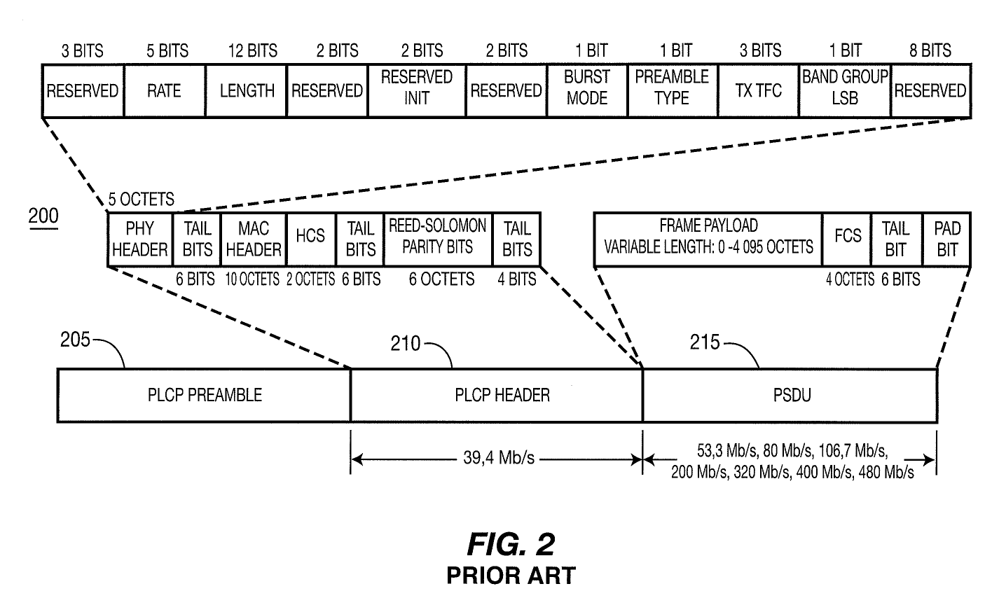

FIG. 2 shows and example of a physical-layer frame structure of an ECMA-368 UWB OFDM system. The ECMA-368 frame consists of a physical-layer convergence protocol (PLCP) preamble 705, a PLCP header 710, and a PSDU 715. FIG. 2 is not to scale, and, for illustrative purposes, the PLCP preamble 705 and the PLCP header 710 are exaggerated. The PLCP preamble 205 and the PLCP header 210 may be used as training sequences.

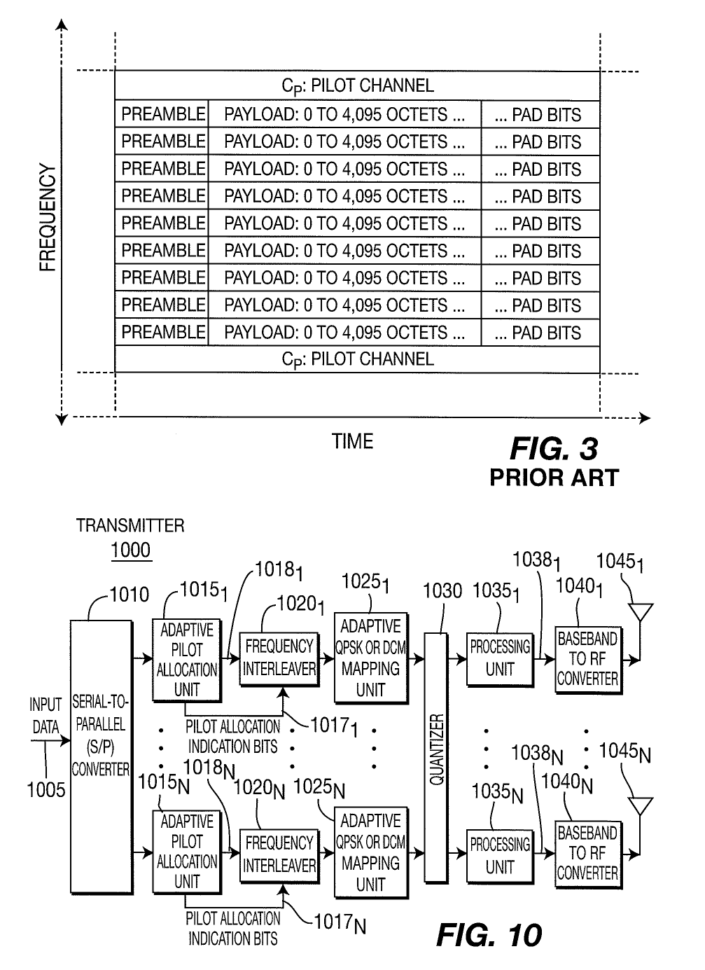

FIG. 3 is a simplified view of the physical ECMA-368 UWB OFDM systems PSDU frame. Prior art methods consider the use of sliding windows that move in both time and frequency directions for best interpolation and seeding. It should be noted that the use of fixed-frequency interleaving (FFI) is assumed where all the frames from a UWB station are transmitted on the same 528 MHz frequency band. A system using time-frequency interleaving (TFI) may be used as well.

The basic constituents of FIG. 3 are:
1) In the horizontal time domain, a frame is flanked by frames before and after it. The time-domain pattern is repeated in both positive (future) and negative (past) directions until the end of the frame boundary is reached.
2) In the vertical frequency domain, pilot sub-channels flank nine data sub-channels. The frequency domain pattern described above is repeated in both positive and negative directions until the guard bands at the end of the frequency band are reached.
3) Pilots occupy continuous time slots in the Pilot sub-channel in the frequency domain. The Data sub-channels use the rest of the sub-channels in the frequency domain.
4) Frame preambles, consisting of the PLCP Preamble and PLCP Header in ECMA-368 systems, could be used for preparatory processing, i.e., where the very initial ‘seed’ for the channel matrix separation procedures, performed in a receiver, for the blind signal extraction in the data portion of the signals is obtained.
5) The boundary between the payload and pad bits is variable depending on the actual size of the payload. The payload data therefore is varying in its average distance from the preamble for the frame, which always is present, and the preamble from the next frame, which may not be present if there is no next frame.

In one embodiment, a method is provided whereby training signals, especially the pilots, are adaptively placed on the frequency domain of a given packet depending on the condition of the channel.

In another embodiment, the condition and quality of the channel can be assessed by the frequency-domain channel estimates obtained by the transmitting UWB device's receiver, based on the previous packets received. From channel estimates thus obtained, the parts of the frequency spectrum can be analyzed and each such part can be determined whether it is suitable to include a pilot symbol within it or not.

In another embodiment, the pilots can be removed in frequency regions where channel quality is excellent. In such frequency regions, good channel estimates may be obtained even without the pilots, since a prior channel estimate obtained from the preamble part, which covers the entire transmission bandwidth, may be sufficient and no pilots may be needed for better channel estimates around the frequency channels that are already excellent. The removed pilots, in turn, may be re-positioned to an area where channel quality is not good, to aid estimation of channels in and around frequency regions where existing pilots may not be sufficient to produce good channel estimates.

In another embodiment, pilots can be removed in frequency regions where channel quality is very poor. This may take place if the transmitting UWB device decides either to remove data symbols from the poor-quality channels altogether, thereby negating the need to maintain pilots in and around these frequency channels, or if the transmitting UWB device does not quite remove all data symbols but if it applies more error-resistant modulation/coding schemes for the data symbols to be mapped onto these poor-quality frequency channels. In the latter case, the removal of the pilot channels may be tolerated because of the strengthened error protection. Again, the removed pilots can be re-positioned to other frequency channels to aid finer channel estimates around those frequency channels.

In another embodiment, the pilots may be removed from both extremely excellent frequency channels and extremely poor frequency channels, and the removed pilots may be re-positioned to the remaining frequency channels.

In order to determine which pilot channels are to be removed and/or re-positioned, the entire transmit bandwidth for a given packet can be partitioned into overlapping or non-overlapping sub-channel parts each consisting of one or multiple frequency bins. Each such sub-channel parts can then be analyzed for their suitability to retain or remove/reposition pilot channels.

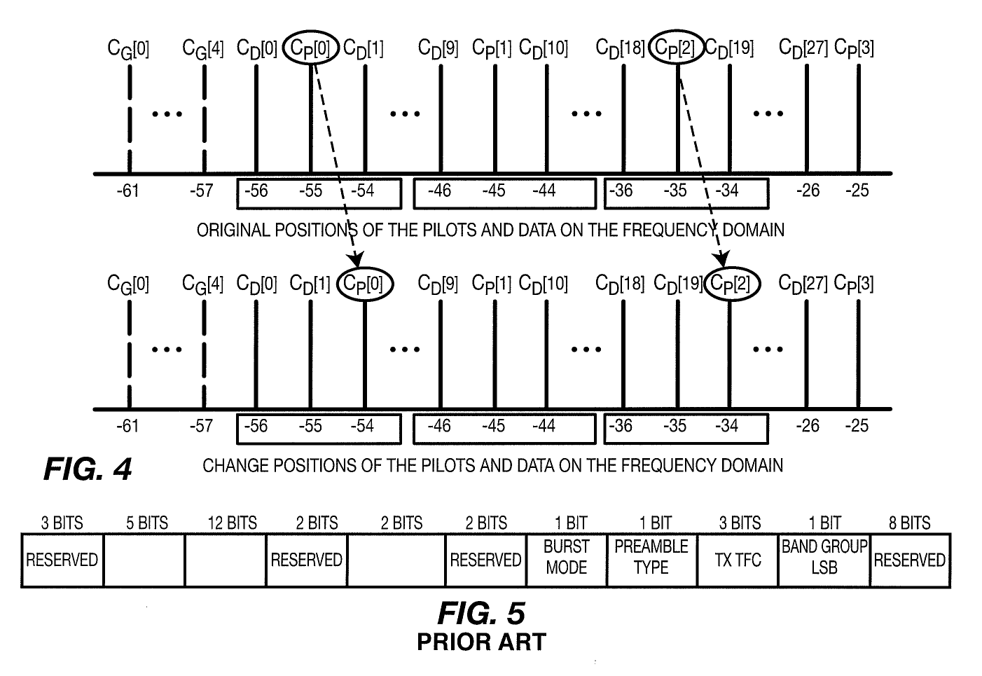

FIG. 4 illustrates two pilot channels, C_{P}[0] and C_{P}[2], that were originally placed on the frequency sub-channels −55 and −35 respectively. They are removed and repositioned to different frequency sub-channels −54 and −34, respectively. Note that the positions of the data channels also change, due to the change in the pilot channel's positions. However, the new positions of the data channel can be easily determined if the changes in the positions of the pilot channels are known and indicated, since the sequence of the data channel positions is really not changed except for the interspersed poisoning of the pilot channels. Thus, only the changes in the positioning of the pilot channels has to be conveyed to the receiving UWB device or WTRU, for it to be able to determine which frequency channels contain the new positions of the pilots. In the structures of the pilot placement in the original ECMA-368 specification, the frequency channels are grouped by 10 frequency bins, or sub-channels, comprised of one pilot channel and 9 data channels. These 10-bin intervals are indicated by the rectangular boundaries in the FIG. 4. Frequency bins −56 to −47 comprise the first 10-bin interval, and the bins −46 to −37 comprise the next 10-bin interval, and so on.

Since in most situations the portion of the UWB spectrum where significant interference exists is likely to be small compared to the whole spectrum, it is likely that the number of frequency parts, or bins, that are affected by such interference is proportionately very small compared to the whole number of such parts, or bins. Therefore, if a UWB device uses a method where pilots are removed and repositioned from severely impaired frequency channels only, then once such bins are determined, the transmitting UWB device may only need to indicate to the receiving UWB device the locations or indices of the relatively few frequency bins that are affected.

For the particular application to the ECMA-368 UWB OFDM packet format, in one embodiment, some of the available reserved bits in the physical layer (PHY) PLCP header are used to indicate the indices of the frequency bins where pilots are either removed or added.

FIG. 5 illustrates that in the currently proposed ECMA-368 UWB PLCP header format, a total of 15 reserved bits are reserved in 4 different reserved bit fields.

In one embodiment, some of the ‘reserved’ bits are used for various indications proposed. Since there are 12 pilot channels in ECMA-368, 12 bits are required to indicate whether any of the pilot channels are removed or repositioned. For example, a bit string of 000010010001 would indicate that the 5^{th}, 8^{th}, and the 12^{th} pilots are removed or repositioned. In addition, for each pilot that is re-positioned, one may need up to 4 bits to indicate where that pilot is re-positioned if the pilot can re-position only within the same 10-bin frequency interval where the pilot was originally placed.

One embodiment of a method to use these reserved bits for the indication of the changed positions of the frequency bins is to apply additional constraints on the positions that the pilots can be removed/re-positioned, as there are only 15 bits to use only the reserved bits are used.

By way of example, it is possible to use a constraint where first, only one out of every three pilots can be removed or repositioned, and secondly, a pilot can be removed from one position to another that is within 8 frequency bins away from the original position within the same 10 frequency bins that included the original position of the displaced pilot. The first constraint means that there can be at most 4 pilots that can be removed/repositioned, requiring 2 of the reserved bits. The second constraint means another 3 bits are required, per repositioned pilots. If the maximum of 4 pilots are removable/repositionable, then at most 15 bits are required to indicate which pilot positions are removed, and where they are repositioned, under the stated constraint. Since the ECMA-368 PLCP header already has 15 reserved bits, one could just use these bits for this indication.

Turning back to FIG. 4, there is shown a signal where only one pilot is removed and replaced to a new position within the same 10-bin interval where the original pilot was positioned.

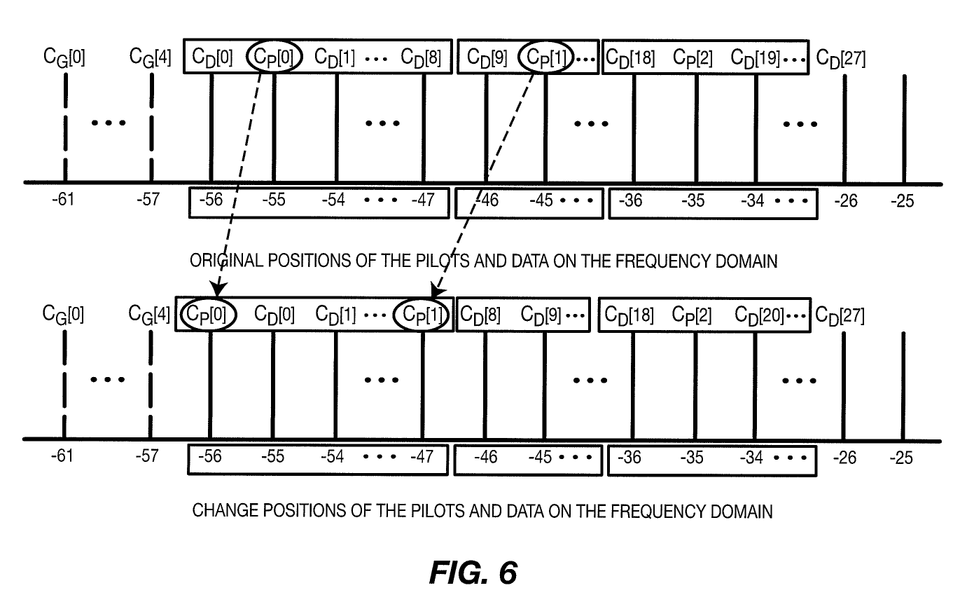

By way of another example, it is possible not to constrain where the new positions can be located. It is possible to remove a pilot position within one 10-bin interval, and re-position this pilot symbol to another 10-bin interval where there was already a pilot. That other pilot could be repositioned. FIG. 6 illustrates such a situation.

In FIG. 6, the original pilot symbols C_{P}[0] and C_{P}[1] on frequency bins −55 and −45, respectively, are re-positioned to frequency bins −56 and −47, respectively. Shown after re-positioning, the first 10-bin interval now contains two pilot bins. Also shown is that the second 10-bin interval does not contain a pilot after the re-positioning. Again, it is possible to apply some constraints in order to use the 15 reserved bits to indicate the repositioning of the pilots in different ways.

If the pilot removal and repositioning is done with little or no constraints on where they can be removed and repositioned, using just the 15 reserved bits may not be adequate. Therefore, it may be possible to use the reserved bits in more than one packet to convey the change in the positions of the pilots. For example, if PLCP headers in two successive packets are to be used, a total of 30 reserved bits will be available to indicate the positional changes in the pilots. The cost to use multiple PLCP headers, on the other hand, is increased delays, (latencies) in the indication of the change in the pilots, from the transmitting UWB device to its intended recipient.

Another possible method to use for the indication of the changed positions of the pilots and data channels is by way of a new type of control packet. This method would require a new definition of a special control packet that is currently not in the ECMA-368 specification.

Another similar method is to extend the definition of some existing packet types, such as the ACK packet, to include sufficiently many bits to indicate the new positions of the pilots.

It is left to determine how the transmitting UWB device can determine which pilot frequency channels are under the influence of severe channel impairment and need to repositioned. One method for such determination is to use frequency-domain channel estimate results from the reverse-link. By way of example, assume UWB Device A wishes to assess which of the current pilot positions need to be replaced/repositioned while communicating with another Device B. Device A can first obtain the channel estimate from its reception of reverse-link packets that it has received from Device B. Then, Device A can compute an estimate of the reciprocal channel, i.e., the channel from the Device A to Device B. This estimate is then analyzed to assess whether any portions of the frequency spectrum, i.e., any frequency bins, are likely to have been severely impaired. After the impaired frequency bins are identified, and if it is determined that some of the impaired frequency bins are on or very near the frequency bins that are previously assigned to have pilot symbols, then the pilots on those bins could be removed and replaced with data symbols instead. Similarly, a pilot channel can be re-positioned to frequency bins that are different from the ones where the pilot channel has been originally assigned to. One option of doing it may be to reposition the pilot channel to a frequency bin half-way between its strongest nearest-neighbor pilot-channel frequency bin and the frequency bin where its pilot channel is removed.

Another method to determine which pilot channels are to be removed and/or repositioned may be by direct indication from the receiving UWB device. This can be done, again, either by using some of the reserved bits in the PLCP header of packets from the receiving UWB device. This is similar to the method for designating the pilot position change on the transmitter device, but using different reserved bits than is used in the transmitter device. Alternatively, a newly defined control packet may be used, or a new extension of a positive acknowledgement (ACK) or request-to-send (RTS) packet from the receiving device may be employed.

Set forth below are a number of embodiments of a method whereby information carrying data symbols can be adaptively allocated using adaptive modulation coding on different frequency channels (bins) within a UWB OFDM packet.

In one embodiment of such a method, estimates of the frequency channel, obtained for example by the several methods that were already described in the previous section, can be used to identify which frequency bins are of good quality, for example, high signal-to-noise ratio and which are of poorer quality. The transmitting UWB device then can allocate more information bits, using higher-order modulation schemes and/or lower-rate channel coding scheme, in or around the frequency bins with high channel quality. The device can also allocate fewer information bits, using lower-order modulation schemes and/or higher-rate channel coding scheme, in or around the frequency bins with low channel quality. Adaptive bit allocation over frequency bins is done within a packet, unlike the schemes used in existing UWB OFDM systems such as the ECMA-368 systems.

Assume that the transmitting UWB device uses an adaptive bit allocation scheme over different frequency bins within a packet. In order for the receiving UWB device to demodulate the signal correctly, it will need to know which of the frequency bins used what kind of modulation or channel coding schemes. Multiple embodiments of a method for solving this problem are set forth below.

Initially, some of the reserved bits in the PLCP header can be used to indicate the variation of the modulation and/or channel coding according to different frequency bins. Since there are only 15 reserved bits in the ECMA-368 standard, one may need to use more than one packet, and thus more than one PLCP header and its associated reserved bits to be able to indicate a detailed partitioning of the bit allocation over frequency bins. There are 100 data channels within the 128 available frequency channels. If two different bit allocation schemes for each of the data channels are used, and the ability to adaptively allocate bits to all of the data channels are required, 100 indication bits are required. Further constraints may be in place to reduce the number of the required reserved bits for the indication. For example, the 100 data channels can be divided to 10 consecutive, non-overlapping bin-intervals, each with 10 data channels within it. Then, one only needs 10 bits to indicate which bit-allocation scheme (out of the possible two) any one 10-bin interval would use.

Secondly, similar to the method for indication of pilot removal/re-position set forth above, more than one PLCP header and its available reserved bits can be used to indicate adaptive bit allocation on different frequency bins (or bin intervals).

Thirdly, similar to the methods set forth above, a new control packet (frame) type may be used wherein the frame has control fields defined to indicate the adaptive allocation of bits.

Set forth below is a method for adaptively allocating a different number of information bits to the different frequency bins.

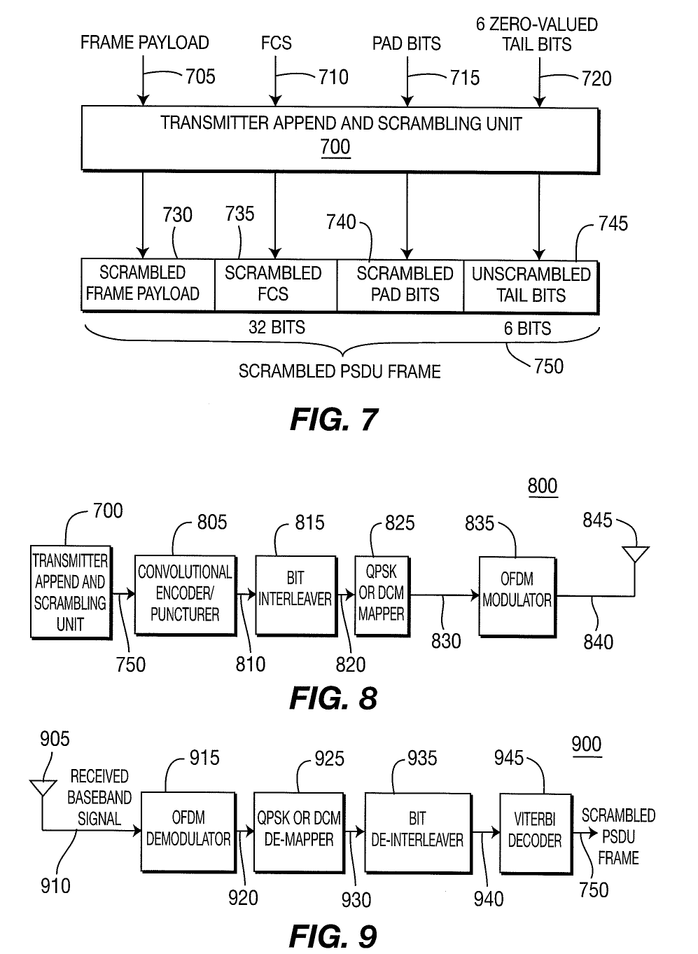

FIG. 7 shows a transmitter append and scrambling unit 700 of an ECMA-368 system, which formats PSDU frames, i.e., the packets that contain the information-carrying data symbols in the physical layer (PHY) level. The transmitter append and scrambling unit 700 scrambles a frame payload 705 that carries information-carrying data bits, with a 32-bit frame check sequence (FCS) 710, and packet assembler/disassembler (PAD) bits 715. Six (6) “zero”-valued tail bits 720 are also input to the transmitter append and scrambling unit 700. The transmitter append and scrambling unit 700 appends together a scrambled frame payload 730, 32 scrambled FCS bits 735, scrambled PAD bits 740 and unscrambled zero-valued tail bits 740 to form a scrambled PSDU frame 750.

FIG. 8 shows an example of transmitter 800 that includes the transmitter append and scrambling unit 700. Additionally, the transmitter may further include a convolutional encoder/puncturer 805, a bit interleaver 815, a modulation mapper 825, an OFDM modulator 835 and a transmit antenna 845. The modulation mapper 825 may be a QPSK modulation mapper or a DCM mapper. The transmitter 800 may be incorporated into a WTRU and/or a base station.

Referring to FIG. 8, the scrambled PSDU frame 750 output by the transmitter append and scrambling unit 700 is fed into the convolutional encoder/puncturer 805, which outputs encoded and punctured bits 810 that are then bit-interleaved by the bit interleaver 815. Then, using knowledge on the transmit channel characteristics, the modulation mapper 825 selects either QPSK modulation or the DCM as the mapping for a particular frequency bin, and then maps the interleaved bits 820 to the selected modulation mapping (QPSK or DCM). The mapped bits 830 output by the modulation mapper 825 are then fed into the OFDM modulator 835, which modulates the mapped bits 830 to produce OFDM-modulated output bits 840 that is transmitted via the transmit antenna 845.

FIG. 9 shows an example of a receiver 900 that re-constructs the scrambled PSDU 750. The receiver 900 may include a receive antenna 905, an OFDM demodulator 915, a de-mapper 925, a bit de-interleaver 935 and a Viterbi decoder 945. The de-mapper 925 may be a QPSK modulation de-mapper or a DCM de-mapper. The receiver 900 may be incorporated into a WTRU and/or a base station.

Referring to FIG. 9, a baseband signal 910 received by the receive antenna 905 is demodulated by the OFDM demodulator 915. The resultant demodulated signal 920 is fed into the de-mapper 925, which first selects, using information on the channel characteristics, either a QPSK modulation de-mapping or a DCM de-mapping, and then de-maps the demodulated signal 920 accordingly. The de-mapped signal 930 is then fed into the bit de-interleaver 935, which de-interleaves the de-mapped signal 930. The bit de-interleaver 935 outputs de-interleaved bits 940, which are fed into the Viterbi decoder 945. The Viterbi decoder 945 outputs the scrambled PSDU 750, which may be further processed (scrambled and de-appended) to produce a PSDU frame payload (not shown).

Set forth below are alternative embodiments of a method for adaptive allocation of the bits onto different frequency bins can be performed in many different ways for slightly modified versions of ECMA-368 PSDU.

One embodiment includes adaptive allocation by variable use of QPSK versus DCM. The transmitting UWB device allocates information bits to different channel frequency bins by using different modulation mapping per different frequency bins. For example, where frequency channels are excellent and superior to the average of all the frequency channels, information bits that would have been QPSK modulated may be up-modulated to DCM. Likewise, where frequency channel quality is very poor, information bits that would have been DCM modulated may be down-modulated to QPSK. The signals then are mapped to an OFDM modulator using IFFT.

At the receiving UWB device, the receiver first converts the OFDM signal back to the frequency domain by applying FFT. Then, using an indication, obtained by, for example, reading the PLCP header reserved bits, as explained in the previous paragraphs of this section, regarding which modulation scheme correspond to which frequency bins, the receiver can then collect the received bits into two partitions, one corresponding to a set of frequency bins and containing the bits that were modulation-mapped to QPSK by the transmitting UWB device, and the other partition corresponding to the other set of frequency bins and containing bits that were modulation-mapped to DCM by the transmitting UWB device. The receiver then can de-map the modulated signals separately from the two partitions. After the two sets of signals are demodulated, one by QPSK, and the other by DCM demodulation, the demodulated bits are collated again, in the correct order reflecting the order of the frequency bins, and proceeds to further receiver processing such as bit interleaving, convolutional decoding, and descrambling, as depicted FIG. 9.

This particular solution requires only a modest change to the existing transmitter and receiver procedures of ECMA-368 systems. The transmitter would need to maintain two sets of signals, one to use DCM and the other to use QPSK. The receiver, in order to maintain two sets of signals, also would need to be designed to be able to perform both QPSK and DCM demodulations. The only other change to the ECMA specification would be the indication methods set forth above.

Another embodiment of the method includes adaptive allocation by variable use of channel coding rates. In this embodiment different channel coding rates per different frequency bins with different channel qualities are used. The ECMA-368 specification, for example, provides 4 different channel coding rates, ⅓, ½, ⅝, and ¾, by using a base ⅓ convolutional encoder coupled with four different puncturing schemes. One, therefore, could identify up to 4 different levels of channel quality, partition the frequency bins according to the 4 quality-levels, and use different channel coding rates on symbols to be carried on different frequency bins. This requires a change of interleaving and QPSK/DCM mapper, as well as OFDM modulator, in the transmit side, in which that the transmitter would have to maintain four different sets of information bits, and separately channel code, interleave, modulation map (to QPSK or DCM), and then separately modulate to the OFDM, and then combine the up to four different OFDM signals in the time domain by superposing them.

At the receiver, one would also need to have essentially four different receivers as depicted in FIG. 9, one each for each of the bit streams that in the transmitter had been encoded with one of the four different channel coding rates.

Another embodiment includes using a mix of variable modulation and channel coding rates on the different frequency bins. This would be hybrid combination of the two embodiments set forth above, and requires more modification of the ECMA-368 specification. However, this method would enable up to 8 different levels of bit allocation on to different frequency channels with different qualities.

FIG. 10 is an example of a multiple-input multiple-output (MIMO) UWB-OFDM transmitter 1000 with N antennas. Note that for the current state of art in the UWB-OFDM standard, such as ECMA-368, is based on a single-input single-output (SISO) system where N=1. The transmitter 100 may include a serial-to-parallel (S/P) converter 1010, adaptive pilot allocation units 1015₁-1015_{N}, frequency interleavers 1020₁-1020_{N}, adaptive mapping units 1025₁-1025_{N}, a quantizer 1030, processing units 1035₁-1035_{N}, baseband to radio frequency (RF) converters 1040₁-1040_{N} and transmit antennas 1045₁-1045_{N}. The adaptive mapping units 1015₁-1015_{N} may be adaptive QPSK modulation mapping units or adaptive DCM mapping units. The transmitter 1000 may be incorporated into a WTRU and/or a base station.

Referring to FIG. 10, the S/P converter 1010 converts a baseband data input signal 1005 into N parallel bit streams. Each of the adaptive pilot allocation units 1015₁-1015_{N} adaptively allocates pilots in the frequency bin, and generate pilot allocation indication bits 1017₁-1017_{N}, which the frequency interleavers 1020₁-1020_{N} use to determine the frequency bins to interleave the parallelized input signals 1018₁-1018_{N}. The adaptive pilot allocation units 1015₁-1015_{N} also output data bits 1018₁-1018_{N}, which have been multiplexed to respective ones of the N parallel bit streams output by the S/P converter 1010. The output data bits 1018₁-1018_{N} are generated in the adaptive pilot allocation units 1015₁-1015_{N}, using the knowledge of the channel, and then carried by some or all of the reserved bits in the PSDU header (215 in FIG. 2). The pilot allocation indication bits 1017₁-1017_{N} are carried on some or all of the reserved bits (shown in FIG. 5) in the 5-Octet PHY header portion of the PLCP header (210 in FIG. 2). After frequency interleaving, the adaptive mapping units 1025₁-1025_{N} map the outputs of the frequency interleavers 1020₁-1020_{N} to either QPSK modulation or DCM, which selection is adaptively made based on pilot allocation and information about the frequency channel corresponding to the frequency bins. The QPSK modulation or DCM-mapped signals are then quantized by the quantizer 1030, and the resulting signals are transformed into time-domain signals and appended with guard band bits by the processing units 1035₁-1035_{N}. Then, the resulting signals 1038₁-1038_{N} are converted to analog RF signals by the baseband to RF units 1040₁-1040_{N}. Finally, the RF signals are transmitted from the antennas 1045₁ to 1045_{N}.

Note that FIG. 10 depicts a MIMO transmitter. For a SISO transmitter with 1 antenna, the S/P converter 1010 is removed and there will be one sequence of units 1015 to 1045, without the indices. However, the rest of the operations would be similar to those as described for FIG. 10.

Although the features and elements are described in the embodiments in particular combinations, each feature or element can be used alone without the other features and elements of the embodiments or in various combinations with or without other features and elements. The methods or flow charts may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A transmitter comprising:
a scrambling unit configured to generate a scrambled physical layer service data unit (PSDU) frame;
a convolutional encoder configured to generate encoded and punctured bits based on the scrambled PSDU frame;
a bit interleaver configured to interleave the encoded and punctured bits;
a modulation mapper configured to map the interleaved bits to an appropriately selected mapping and generate mapped interleaved bits;
an orthogonal frequency division multiplexing (OFDM) modulator configured to modulate the mapped interleaved bits to produce OFDM-modulated output bits; and
a transmit antenna configured to transmit the OFDM-modulated output bits.

2. The transmitter of claim 1 wherein the modulation mapper is a quadrature phase shift keying (QPSK) modulation mapper.

3. The transmitter of claim 1 wherein the modulation mapper is a double carrier modulation (DCM) mapper.

4. The transmitter of claim 1 wherein the modulation mapper selects, using knowledge of transmit channel characteristics, either quadrature phase shift keying (QPSK) modulation or double carrier modulation (DCM) as the mapping for the interleaved bits output by the bit interleaver for a particular frequency bin, and then maps the interleaved bits to an appropriately selected QPSK modulation or DCM mapping.

5. A wireless transmit/receive unit (WTRU) comprising the transmitter of claim 1.

6. A base station comprising the transmitter of claim 1.

7. A receiver comprising:
a receive antenna configured to receive a baseband signal;
an orthogonal frequency division multiplexing (OFDM) demodulator configured to demodulate the received baseband signal;
a modulation de-mapper configured to de-map the demodulated signal;
a bit de-interleaver configured to de-interleave the de-mapped signal; and
a Viterbi decoder configured to generate a scrambled physical layer service data unit (PSDU) frame based on the de-interleaved de-mapped signal.

8. The receiver of claim 7 wherein the modulation de-mapper is a quadrature phase shift keying (QPSK) modulation de-mapper.

9. The receiver of claim 7 wherein the modulation de-mapper is a double carrier modulation (DCM) de-mapper.

10. The receiver of claim 7 wherein the modulation de-mapper selects, using information on receive channel characteristics, either a quadrature phase shift keying (QPSK) modulation de-mapping or a double carrier modulation (DCM) de-mapping, and then de-maps the demodulated signal accordingly.

11. The receiver of claim 7 wherein the scrambled PSDU frame is scrambled and de-appended to produce a PSDU frame payload.

12. A wireless transmit/receive unit (WTRU) comprising the receiver of claim 7.

13. A base station comprising the receiver of claim 7.

14. A multiple-input multiple-output (MIMO) ultra-wideband (UWB)-orthogonal frequency division multiplexing (OFDM) transmitter comprising:
a serial-to-parallel (S/P) converter configured to convert a data input signal into N parallel bit streams;
a plurality of adaptive pilot allocation units configured to adaptively allocate pilots in a frequency bin, and generate bit-allocation indication bits;
a plurality of frequency interleavers configured to determine the frequency bins to interleave respective ones of the parallel bit streams and generate interleaved bits;
a plurality of adaptive modulation mapping units configured to map the interleaved bits to either quadrature phase shift keying (QPSK) modulation or double carrier modulation (DCM), which selection is adaptively made based on pilot allocation and information about the frequency channel corresponding to the frequency bins;
a quantizer configured to quantize the QPSK modulation or DCM mapped signals;
a plurality of processing units configured to transform the mapped signals into time-domain signals and append guard band bits to the time-domain signals;
a plurality of baseband to radio frequency (RF) converters configured to convert the time-domain signals to RF signals; and
a plurality of transmit antennas configured to transmit the RF signals.

15. A wireless transmit/receive unit (WTRU) comprising the transmitter of claim 14.

16. A base station comprising the transmitter of claim 14.

17. A single-input single-output (SISO) ultra-wideband (UWB)-orthogonal frequency division multiplexing (OFDM) transmitter comprising:
an adaptive pilot allocation unit configured to adaptively allocate pilots in a frequency bin, and generate bit-allocation indication bits;
a frequency interleaver configured to determine the frequency bins to interleave and output interleaved bits;
an adaptive modulation configured to map the interleaved bits to either quadrature phase shift keying (QPSK) modulation or double carrier modulation (DCM), which selection is adaptively made based on pilot allocation and information about the frequency channel corresponding to the frequency bins;
a quantizer configured to quantize the QPSK modulation or DCM mapped signals;
a processing unit configured to transform the mapped bits into time-domain signals and append guard band bits to the time-domain signals;
a baseband to radio frequency (RF) converter configured to convert the time-domain signals to RF signals; and
a transmit antenna configured to transmit the RF signals.

18. A wireless transmit/receive unit (WTRU) comprising the transmitter of claim 17.

19. A base station comprising the transmitter of claim 17.

20. A method of configuring reserved bits in an ultra-wideband (UWB) orthogonal frequency division multiplexing (OFDM) packet having a physical layer convergence protocol (PLCP) header, the method comprising:
allocating pilots among data bits in a frequency plane; and
configuring at least a portion of the available reserved bits in the PLCP header to indicate the indices of frequency bins where the pilots are either removed or added.

21. A method of indicating the repositioning of pilot channels, the method comprising:
removing a plurality of pilot channels from a first set of respective frequency sub-channels;
repositioning the pilot channels to a second set of respective frequency sub-channels; and
conveying changes in the positioning of the pilot channels to a wireless transmit/receive unit (WTRU) using reserved bits in a physical layer convergence protocol (PLCP) header of an ultra-wideband (UWB) orthogonal frequency division multiplexing (OFDM) packet such that the WTRU is able to determine which frequency channels contain the new positions of the pilot channels.

22. The method of claim 21 wherein 12 reserved bits are required to indicate whether any of the pilot channels are removed or repositioned.
